(19) United States
(12) Patent Application Publication
(10) Pub. No.: US 2009/0236318 A1
(43) Pub. Date: Sep. 24, 2009

(54) Wire Electric Discharge Machining Apparatus

(76) Inventor: Masashi Sakaguchi, Kanagawa (JP)

Correspondence Address: MCDERMOTT WILL & EMERY LLP, 18191 VON KARMAN AVE., SUITE 500, IRVINE, CA, 92612-7108, US

(21) Appl. No.: 12/083,198

(22) PCT Filed: Mar. 22, 2007
(86) PCT No.: PCT/JP2007/000282

§ 371 Date: Apr. 7, 2008

(30) Foreign Application Priority Data
Mar. 22, 2006 (JP) 2006-078467

(51) Int. Cl. B23H 7/02

(52) U.S. Cl. 219/69.12

(57) ABSTRACT

A wire electric discharge machining apparatus can select a split guide formed from a pair of guide pieces, or an unsplittable dice guide, as an upper wire guide. An upper wire guide assembly includes a housing configured to selectively store the split guide or an adapter that the dice guide fitted into, and an actuator configured to move at least one of the pair of guide pieces. When the split guide is selected, a guide pipe configured to form a fluid jet can be moved downward through the upper wire guide assembly. When the dice guide is selected, an AWT jet nozzle configured to form a fluid jet can be attached to the adapter. Further, a jacket can be attached to the housing, the jacket having a fluid inlet configured to introduce fluid to be supplied to the AWT jet nozzle.

### CROSS-REFERENCE TO RELATED APPLICATION

This application is a National Stage application of International Application No. PCT/JP2007/000282, with an international filing date of Mar. 22, 2007.

### FIELD

The present invention relates to a wire electric discharge machining apparatus for machining a workpiece using a wire electrode that is running between a pair of wire guides. In particular, the present invention relates to a wire electric discharge machining apparatus provided with an automatic wire threader (“AWT”) for threading a wire electrode through guide holes of the pair of wire guides using a fluid jet.

### ART

A wire guide assembly provided with a passage in which the wire electrode runs vertically, and a power feed contact, a wire guide and a flushing nozzle integrally combined along this passage, is known. Wire guide assemblies are attached to respective tips of upper and lower arms fixed to a head or a column. The power feed contact is a contact for supplying electrical current to a running wire electrode. The diameter of wire electrode is typically 0.20 mm or 0.25 mm. The wire guide typically has a guide hole that is 0.01 mm or 0.02 mm larger than the wire electrode. The flushing nozzle is attached to the wire guide assembly facing the workpiece. During machining, high pressure machining fluid is jetted to a machining gap coaxial with the wire electrode. In the case where an opening of the flushing nozzle is positioned close to the surface of the workpiece, the wire guide assembly is subjected to a strong reaction force due to the high pressure machining fluid. The wire guide assembly is therefore securely fixed to the arm.

Generally, an automatic wire threader for passing the wire electrode through the upper and lower wire guides is provided in a wire electric discharge machining apparatus. Automatic wire threaders in recent years have passed a wire electrode using a fluid jet. Japanese Examined Patent Application Publication No. 7-29246 discloses a pipe jet type automatic wire threader with a guide pipe that can pass through the wire guide assembly. The wire electrode is placed in the guide pipe and a fluid jet is supplied into the guide pipe. The external diameter of the guide pipe is normally about 2 mm. In the case where a pipe jet type automatic wire threader is used, it is typically necessary to form a passage through which the guide pipe can pass in the wire guide assembly. Therefore, the wire guide assembly includes an actuator for moving the wire guide and the power feed contact. Japanese registered utility model No. 2521251 discloses a wire guide capable of being split into a pair of guide pieces in order to allow a guide pipe to pass through (“split guide”). Each guide piece is manufactured from a hard material. If the pair of guide pieces are joined together, a substantially rectangular wire guide is formed, and a guide hole is formed in the joined section.

Unsplittable circular dice guides are said to exhibit higher positioning accuracy than current split guides when the wire electrode is inclined. A fluid jet and guide pipe for an AWT cannot pass through the guide hole of a dice guide. Japanese Laid-open patent application publication No. 5-406647 discloses a jet type automatic wire threader with an AWT jet nozzle provided between a dice guide and a flushing nozzle. The AWT jet nozzle forms a fluid jet for guiding the wire electrode into a start hole in the workpiece, and also into a guide hole of the lower wire guide.

### SUMMARY

In one aspect of the present invention, the subject technology provides a wire electric discharge machining apparatus capable of simply exchanging a split guide with an unsplittable dice guide. In another aspect of the present invention, the subject technology provides a wire electric discharge machining apparatus that can selectively use a pipe jet type or jet type automatic wire threader depending on machining, without changing a wire guide assembly.

In one aspect of the invention, a wire electric discharge machining apparatus for machining a workpiece using a wire electrode that is running vertically between upper and lower wire guides is provided. The apparatus includes an upper wire guide assembly including a housing and an actuator, the housing being configured to selectively store a split guide formed from a pair of guide pieces, or an unsplittable dice guide, as an upper wire guide, and the actuator being configured to move at least one of the pair of guide pieces. The apparatus further includes a guide pipe configured to move vertically through the upper wire guide assembly and configured to form a fluid jet, and means for supplying the fluid jet to the guide pipe.

The housing may store the dice guide fitted into an adapter (70) having at least partially the same external shape as the split guide.

Also, when the housing stores the dice guide, the upper wire guide assembly may further include an AWT jet nozzle configured to form a fluid jet for automatic wire threading. The upper wire guide assembly may further include a jacket (90) having an inlet configured to introduce fluid to be supplied to the AWT jet nozzle.

Also, the upper wire guide assembly may further include a power feed contact, a power feed contact block configured to hold the power feed contact, and a pin fixed to the power feed contact block. The actuator may be connected to the power feed contact block, and the pin may be fitted into at least one (42) of the pair of guide pieces.

Further, when the housing stores the dice guide, the upper wire guide assembly may have an adapter that the dice guide fits into, and the adapter may further include an elongated hole configured to permit movement of the pin.

According to one aspect of the present invention, it is possible to selectively use a split guide or a dice guide depending on the machining. It is also possible to selectively use a pipe jet type or jet type automatic wire threader, by partial replacement of a wire guide assembly.

Additional features and advantages of the invention will be set forth in the description below, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a cross sectional drawing showing an example of a wire guide assembly including a split guide.

FIG. 2 is an exploded view partially showing the wire guide assembly of FIG. 1.

FIG. 3 is a cross sectional drawing showing an example of a wire guide assembly including a dice guide.

FIG. 4 is an exploded view partially showing the wire guide assembly of FIG. 3.

FIG. 5 is another cross sectional view partially showing the wire guide assembly of FIG. 3.

FIG. 6 is a front elevation showing an example of an automatic wire threader.

### DETAILED DESCRIPTION

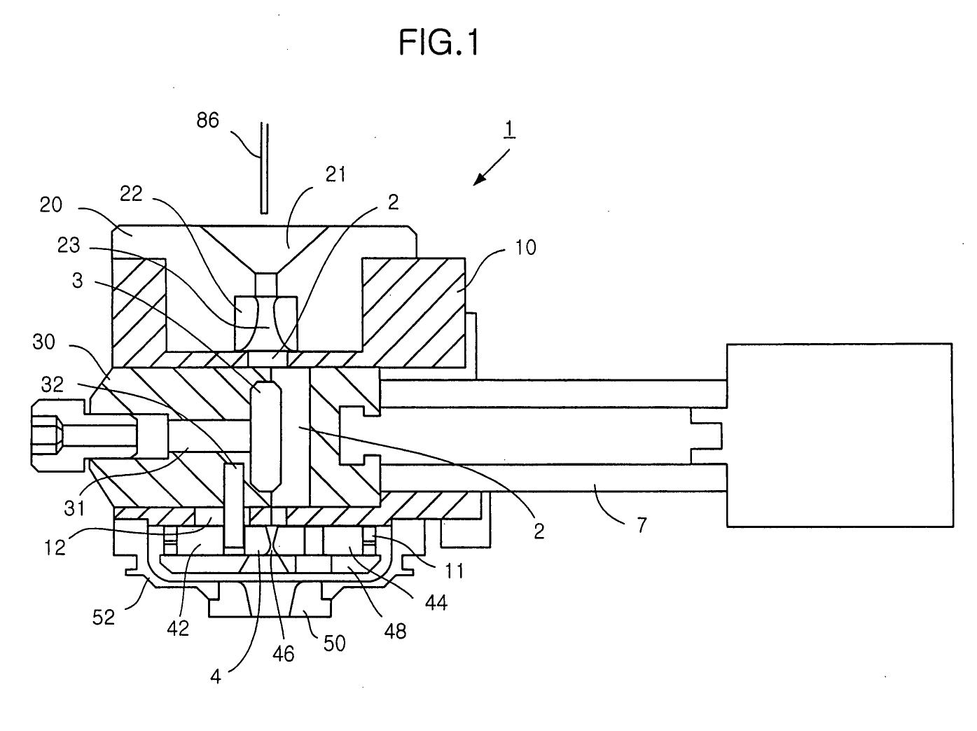

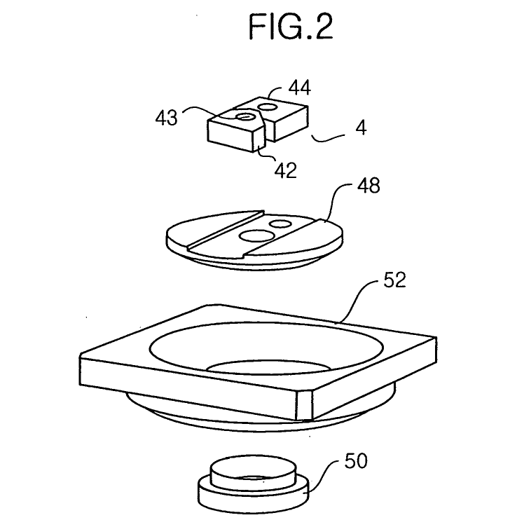

A wire guide assembly including a split guide will be described with reference to FIGS. 1 and 2. The upper wire guide assembly 1 may mainly be constructed from a housing 10, a wire insertion block 20 and a power feed contact block 30. A passage 2 in which the wire electrode (not shown) runs vertically may be provided on the upper wire guide assembly 1. A power feed contact 3, split guide 4 and flushing nozzle 50 may be arranged along the passage 2.

The wire insertion block 20 may be integrally fixed to an upper side of the housing 10. The wire insertion block 20 may have a conical hole 21 and a guide 22. A guide hole 23 of the guide 22 may have a larger diameter than the external diameter of a guide pipe 86 for guiding the wire electrode. The conical hole 21 and the guide hole 23 may constitute part of the passage 2.

The power feed contact block 30 may be provided inside the housing 10 below the wire insertion block 20. The power feed contact 3 may be housed inside the power feed contact block 30 moveably in a direction orthogonal to the wire electrode. The power feed contact block 30 may have a holding member 31 for holding the power feed contact 3. A pin 32 may be fixed to a lower part of a the power feed contact block 30. A pin 32 may extend downwards through an elongated hole 12 formed in a lower part of the housing 10. An actuator 7 formed from an air cylinder may be integrally attached to the housing 10. The actuator 7 may be connected to the power feed contact block 30, and the power feed contact block 30 can be slid horizontally by the actuator 7. As a result of sliding of the power feed contact block 30, the power feed contact 3 may advance or retreat with respect to the wire electrode.

The split guide 4 may be formed from a pair of guide pieces 42, 44. If the guide pieces 42, 44 are joined, a guide hole 46 for the wire electrode may be formed. The guide hole 46 may have a diameter that is 0.01 or 0.02 mm larger than the wire electrode. The split guide 4 may be housed in a recess which is formed by the projecting section 11 of the housing 10, and may be slidably held by a circular plate-shaped guide holder 48. A nozzle cap 52 may be attached with screws to a lower part of the housing 10, so as to cover the guide holder 48. The nozzle cap 52 may be equipped with a flushing nozzle 50. A tip end of the pin 32 is fitted into a through hole 43 of the guide piece 42. In this way, the guide piece 42 may be configured to be slid horizontally by the actuator 7 in order to open and close the split guide 4.

A pipe jet type automatic wire threading method will now be described. First, the power feed contact block 30 may be moved to the left in the drawing by the actuator 7. In this way, the power feed contact 3 and the guide piece 42 may be retracted, and a passage that is sufficiently large to allow the guide pipe 86 to pass through may be formed inside the wire guide assembly 1. The guide pipe 86 may be lowered downwards as far as possible through the wire guide assembly 1. Together with supply of a fluid jet into the guide pipe 86, the wire electrode may be fed downwards into the guide pipe 86. Once the wire electrode passes through the lower wire guide (not shown) and reaches a take-up roller (not shown), automatic wire threading may be completed.

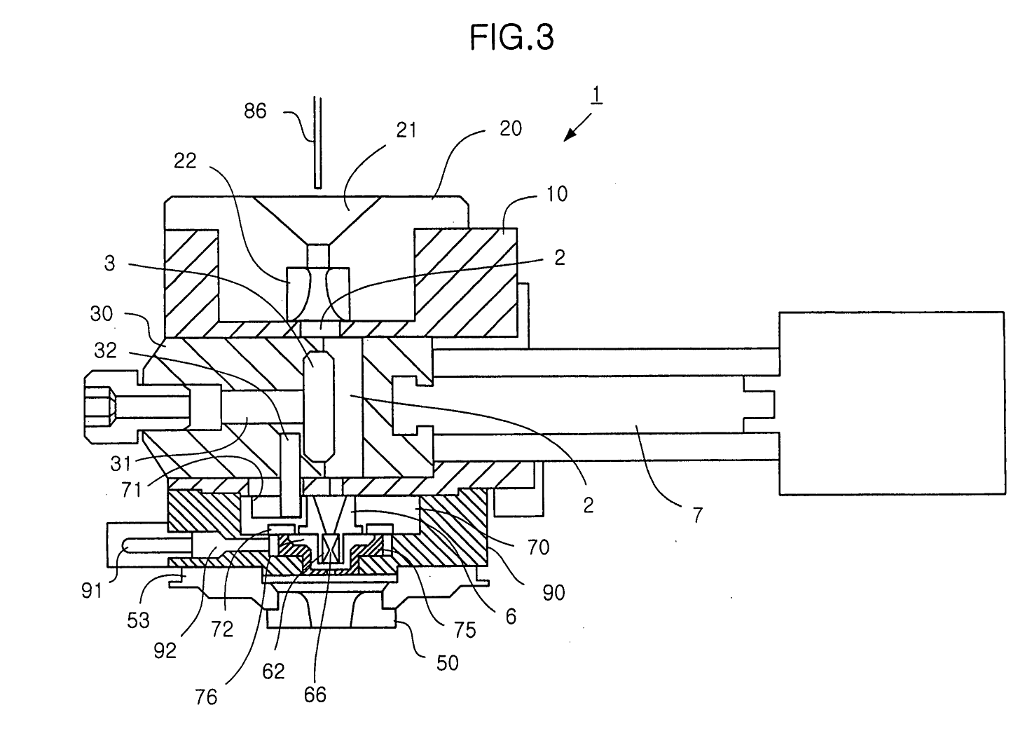

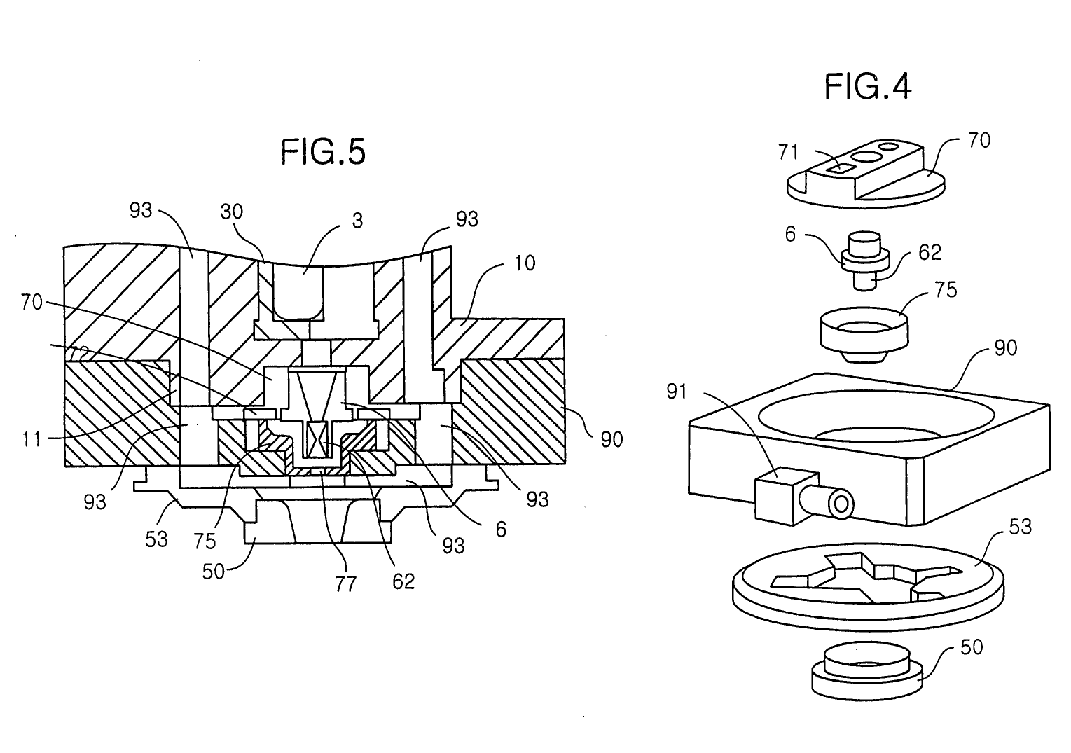

A wire guide assembly including an unsplittable dice guide will be described with reference to FIGS. 3 to 5. Similar elements are labeled with similar reference numerals as used in FIG. 1, and detailed description thereof will be omitted. The dice guide 6 may integrally hold a guide member 62 having a guide hole 66 for the wire electrode. The guide hole 66 may have a diameter that is 0.01 or 0.02 mm larger than the wire electrode. The dice guide 6 may be fitted into the adapter 70.

In order to replace the wire guide, first of all the nozzle cap 52 and the guide holder 48 may be removed from the wire guide assembly 1 of FIG. 1. Next, the split guide 4 may be removed. The adapter 70 holding the dice guide 6 may be attached to a position where the split guide 4 is situated. The adapter 70 may partially have a rectangular external shape that is substantially the same as the split guide 4, and so may be smoothly housed in the recess which is formed by the projecting section 11. The adapter 70 may have an elongated hole 71 into which the pin 32 is inserted. The elongated hole 71 into which the pin 32 is inserted. The elongated hole 71 permits movement of the pin 32.

An AWT jet nozzle 75 may be mounted at an inner side of a jacket 90, and the jacket 90 may be detachably attached to the housing 10. The AWT jet nozzle 75 may be positioned below the dice guide 6 so as to cover the guide member 62. A gap between the dice guide 6 and the AWT jet nozzle 75 may form a flow path 76 for fluid for the AWT jet. A nozzle base 53 equipped with a flushing nozzle 50 may be attached to the jacket 90. An opening 77 of the AWT jet nozzle 75 may be positioned between the guide member 62 and the flushing nozzle 50.

The jacket 90 may have a fluid inlet 91, and a fluid supply path 92 communicating with the fluid inlet 91. The fluid inlet 91 may be connected to a fluid supply device by an appropriate flexible hose (not shown). As shown clearly in FIG. 5, the jacket 90 may further have a supply path 93 through which machining fluid is fed to the flushing nozzle 50. A plurality of counterbores 72 may be formed in a lower part of the adapter 70. The counterbores 72 may communicate with the fluid supply path 92 and the flow path 76.

A jet type automatic wire threading method will now be described. First, the power feed contact block 30 may be moved to the left in the drawing by the actuator 7. In this way, the power feed contact 3 may be retracted, and a tip end of the guide pipe 86 may be lowered to just above the guide member 62. Together with supply of a fluid for an AWT jet into the guide pipe 86, the wire electrode may be fed downwards into the guide pipe 86. A tip of the wire electrode having passed through the dice guide 6 may be constrained by a fluid jet formed by the AWT jet nozzle 75. Fluid for the AWT jet may pass through the fluid inlet 91, fluid supply passage 92, counterbores 72 and the flow path 76, and may be jetted from the opening 77 of the AWT jet nozzle 75. The wire electrode may be fed further downwards while being constrained by the fluid jet. Once the wire electrode passes through the lower wire guide and reaches the take-up roller, automatic wire threading may be completed.

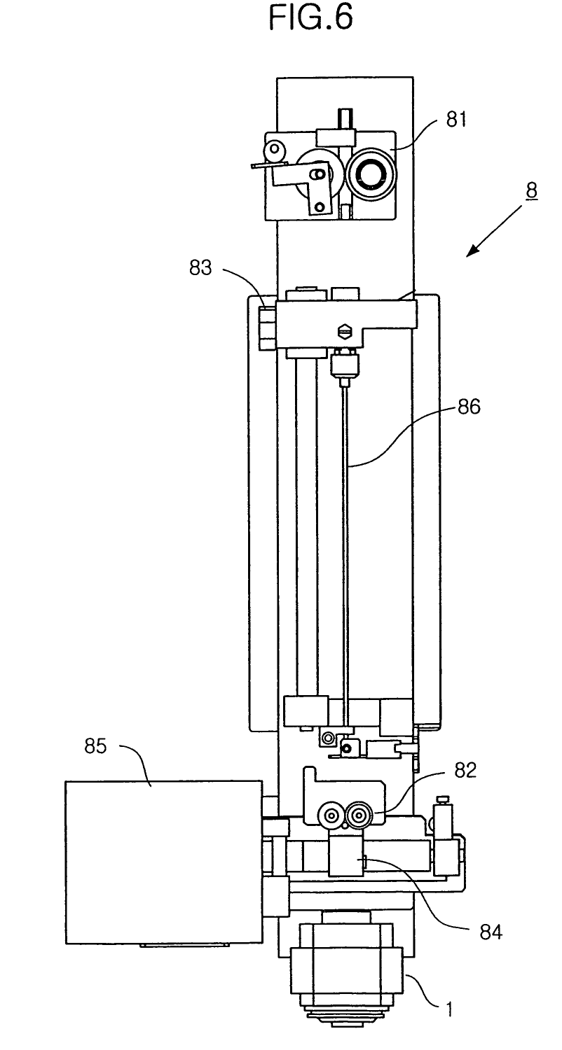

One example of a device for implementing the pipe jet type and jet type automatic threading methods will be described with reference to FIG. 6. The automatic wire threader 8 may include a feed roller 81, cutting roller 82, jet supply port 83, damper 84, collection box 85 and guide pipe 86. An unneeded part of the wire electrode may be cut off by supplying electrical current to the roller 82. The cut off wire piece may be grasped with the damper 84 and supplied to the collection box 85. The guide pipe 86 may be provided below the feed roller 81 for feeding the wire electrode downwards. Fluid for the AWT jet may be introduced from a jet supply port 83 and supplied into the guide pipe 86. The jet supply port 83 may be connected to a fluid supply device by an appropriate flexible hose (not shown).

The embodiments have been chosen in order to explain the principles of the invention and its practical applications, and many modifications are possible in light of the above teaching. It is intended that the scope of the invention be defined by the claims appended hereto.

What is claimed is:

1. A wire electric discharge machining apparatus for machining a workpiece using a wire electrode that is running vertically between upper and lower of wire guides, comprising:
an upper wire guide assembly including a housing and an actuator, the housing being configured to selectively store a split guide formed from a pair of guide pieces, or an unsplittable dice guide, as an upper wire guide, and the actuator being configured to form at least one of the pair of guide pieces;
a guide pipe, configured to move vertically through the upper wire guide assembly and configured to form a fluid jet; and
means for supplying the fluid jet to the guide pipe.
wherein the high frequency induction heating unit can move between the shrink fit holder and a retracted position separated from the shrink fit holder.

2. The wire electric discharge machining apparatus of claim 1, wherein when the housing stores the dice guide, the upper wire guide assembly further includes an adapter which the dice guide is fitted into, the adapter having at least partially the same external shape as the split guide.

3. The wire electric discharge machining apparatus of claim 1, wherein when the housing stores the dice guide, the upper wire guide assembly further includes an AWT jet nozzle configured to form a fluid jet for automatic wire threading.

4. The wire electric discharge machining apparatus of claim 3, wherein when the housing stores the dice guide, the upper wire guide assembly further includes a jacket having an inlet configured to introduce fluid to be supplied to the AWT jet nozzle.

5. The wire electric discharge machining apparatus of claim 1, wherein the upper wire guide assembly further includes a power feed contact, a power feed contact block configured to hold the power feed contact, and a pin fixed to the power feed contact block, and wherein the actuator is connected to the power feed contact block, and the pin is fitted into at least one of the pair of guide pieces.

6. The wire electric discharge machining apparatus of claim 1, wherein when the housing stores the dice guide, the upper wire guide assembly further includes an adapter that the dice guide fits into, the adapter having an elongated hole configured to permit movement of the pin.
